(19) United States
(12) Patent Application Publication
(10) Pub. No.: US 2004/0153579 A1
(43) Pub. Date: Aug. 5, 2004

(54) Virtual disc drive control device

(76) Inventors: Ching-Chih Shih, Tao Yuan Shien (TW); Wen-Yuan Hung, Hsintien City (TW); Shin-Yun Lin, Taipei (TW); Pi-Cheng Chen, Hsin Chuang City (TW)

Correspondence Address: RABIN & BERDO, P.C., Suite 500, 1101 14 Street, N.W., Washington, DC, 20005, US

(21) Appl. No.: 10/448,308

(22) Filed: May 30, 2003

(30) Foreign Application Priority Data
Jan. 30, 2003 (TW) 92102341

(51) Int. Cl. G06F 3/00

(52) U.S. Cl. 710/1

(57) ABSTRACT

A virtual disc drive control device is described. The control device controls a remote disc drive for a local computer via a network. The control device includes an input/output interface, a virtual disc drive simulation firmware, and a network interface controller. The input/output interface receives information from the local computer. The firmware simulates a local disc drive and responses the information. The firmware responds to the information if the firmware is able to answer directly the information. The firmware sends the information to a remote computer if the firmware is not able to answer the information. A remote disc drive agent of the remote computer controls a remote disc drive according the information and responds to the information. The firmware simulates a local disc drive response according to the remote computer response and sends the local disc drive response to the local computer.

### FIELD OF THE INVENTION

The present invention relates to use of a virtual disc drive control device to remote access a remote computer disc drive via a network and especially to use of a virtual disc drive control device to remote access a disc drive of a remote computer or install a new software on a local computer without a disc drive.

### BACKGROUND OF THE INVENTION

Computers have been widely applied in all fields and network technologies have rapidly progressed. Therefore, people can easily access information and provide services by way of networks, and the growing network provides people with a comfortable and fast information environment.

At this time, there is a lot of information to be distributed over the network. Therefore, a network established with only few computers provides insufficient service. Network systems are established with more computers and the computer apparatuses may even be distributed over different places all over the world. The computer apparatuses, such as workstations, servers, database memory, routers, and backup devices, connect with each other via the network so as to provide diverse services.

A blade server provides an advantage of compact containment of a plurality of server blades. Therefore, blade servers can effectively reduce space occupied by servers. Accordingly, the blade servers are widely used in network environments. If the blade server computer wishes to install an application software and in particular to install an operating system thereon, a problem arises due to the lack of an internal optical drive disc in a conventional blade server.

A conventional server computer can be remotely controlled via the network, only if the server computer works with a remote control software based on a working operating system (OS). For this management method, an OS, such as the Windows operating system, supporting the network must already be installed in the server computer and the remote computer. That is to say, the remote computers can control the server computers, and the remote computer can provide an optical disc drive thereof for the server computer via the network only if both the server computers and the remote computers use the OS supporting the network and the remote control software.

But if the supporting network OS of a server computer is not ready or if the server computer does not have the OS installed thereon, the server computer has no way to access the optical disc drive or any other peripheral device of the remote computer. Therefore, if a blade server can access a remote optical disc drive via the network in any condition, the function and convenience of the blade server can be obviously improved for network control and management.

### SUMMARY OF THE INVENTION

One object of the present invention is to provide a virtual disc drive control device to control a remote optical disc drive by a local computer and especially for a blade server via a network.

Another object of the present invention is to provide a virtual disc drive control device that can work with a local computer without an OS, where the local computer can still access the remote optical disc drive. The local computer can control the remote optical disc drive or any other peripheral devices to read and write thereto via the network in any condition, even when the local computer has just been turned on or the OS thereof is being reinstalled.

The present invention provides a virtual disc drive control device to connect a local computer to a remote computer. The control device simulates a local optical disc drive for a local computer controlling a remote optical disc drive or a peripheral device. The control device comprises a control device input/output interface, a virtual disc drive simulation firmware, and a control device network interface controller. The control device input/output interface connects to a local computer input/output interface of the local computer by a cable, such as a USB cable, an IEEE 1394 cable or any other computer cable with series connection capability, to receive local computer information from the local computer input/output interface.

The virtual disc drive simulation firmware simulates the control device in a local virtual disc drive and receives the local computer information from the control device input/output interface. When the control device is able directly to reply the local computer information, the virtual disc drive simulation firmware replies to the local computer information with local computer response information. When the control device is not able to reply directly to the local computer information, the virtual disc drive simulation firmware transforms the local computer information into local computer network packets according to a predetermined network communication protocol, such as a TCP/IP communication protocol. The control device network interface controller sends the local computer network packets to the remote computer and receives remote computer response network packets from the remote computer. The virtual disc drive simulation firmware transforms the remote computer response network packets into the local computer response information and responds to the local computer.

The remote computer comprises a remote computer network interface controller, a central processing unit, and a remote optical drive disc. The remote computer network interface controller receives the local computer network packets. The central processing unit executes a remote disc drive agent program to transform the local computer network packets into a remote computer information. The remote optical drive disc replies to the remote computer information with remote computer response information to the central processing unit. Therefore, the central processing unit transforms the remote computer response information into the remote computer response network packets, and transmits the same to the control device for response to the local computer.

The remote disc drive agent program is a predetermined application program installed on the remote computer or a Java applet automatically downloaded from the control device while the remote computer is connected to the control device.

The present invention can simulate any virtual computer peripheral equipment to control computer peripheral equipment of the remote computer for a local computer.

Hence, the virtual disc drive control device according to the present invention can simulate any computer peripheral equipment of the remote computer for a local computer peripheral equipment so that the local computer without any OS supporting network can remotely access and control the peripheral devices of the remote computer.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic network architecture of a preferred embodiment with a virtual disc drive control device according to the present invention; and

FIG. 2 is a block diagram of a virtual disc drive control device according to the present invention.

### DETAILED DESCRIPTION OF THE PREFERRED EMBODIMENT

The following description is the best presently contemplated mode of carrying out the present invention. This description is not to be taken in a limiting sense but is made merely for the purpose of describing the general principles of the invention. The scope of the invention should be determined by referencing the appended claims.

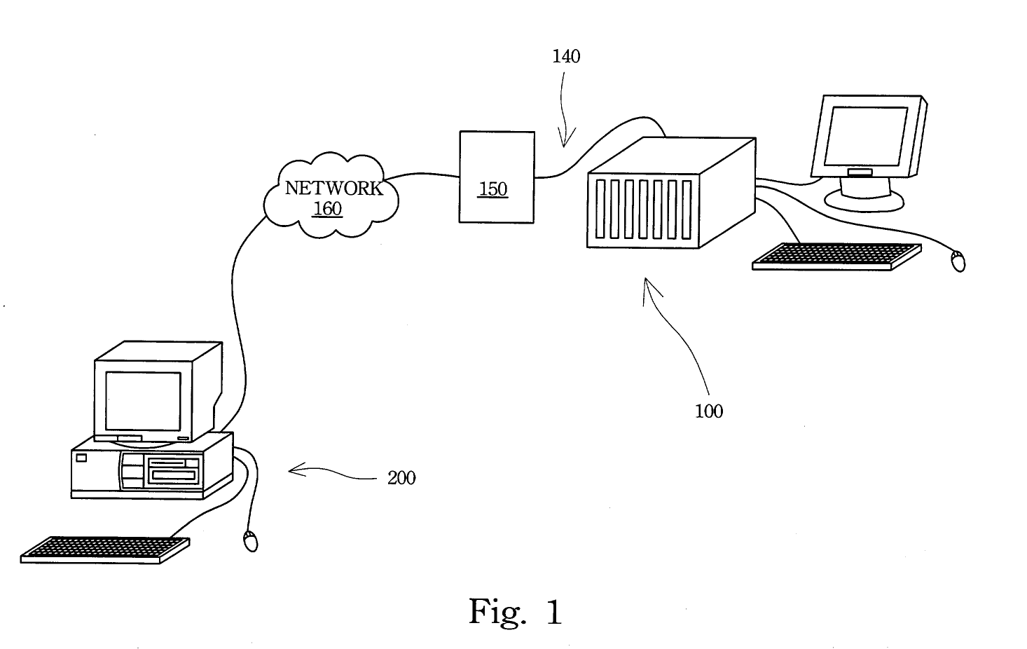

FIG. 1 is a schematic network architecture of a preferred embodiment with a virtual disc drive control device according to the present invention. An optical disc drive of a remote computer can be controlled as a local optical disc drive of the blade server 100 by way of the virtual disc drive control device 150 according to the present invention. The virtual disc drive control device 150 connects to the blade server 100 by a connecting cable 140. The connecting cable 140, such as a USB cable or an IEEE 1394 cable, provides a series connection capability of an input/output port for the blade server 100.

With the virtual disc drive control device 150 according to the present invention, the blade server 100 of the computer system can access the optical disc drive of the remote computer 200 to read and write data therein. Further, by way of the virtual disc drive control device 150, the blade server 100 can always access the optical disc drive of the remote computer 200 whether or not the blade server 100 is working with an operating system which supports the network. Furthermore, whether or not the blade server 100 is working with an operating system, the blade server 100 can remotely access the optical disc drive of the remote computer 200, even while the blade server 100 reboots, sets up the BIOS thereof, or installs the operating system thereof. In any working situation of the blade server 100, with virtual disc drive control device 150 according to the present invention, the blade server 100 can always access the optical disc drive of the remote computer 200 via the network 160.

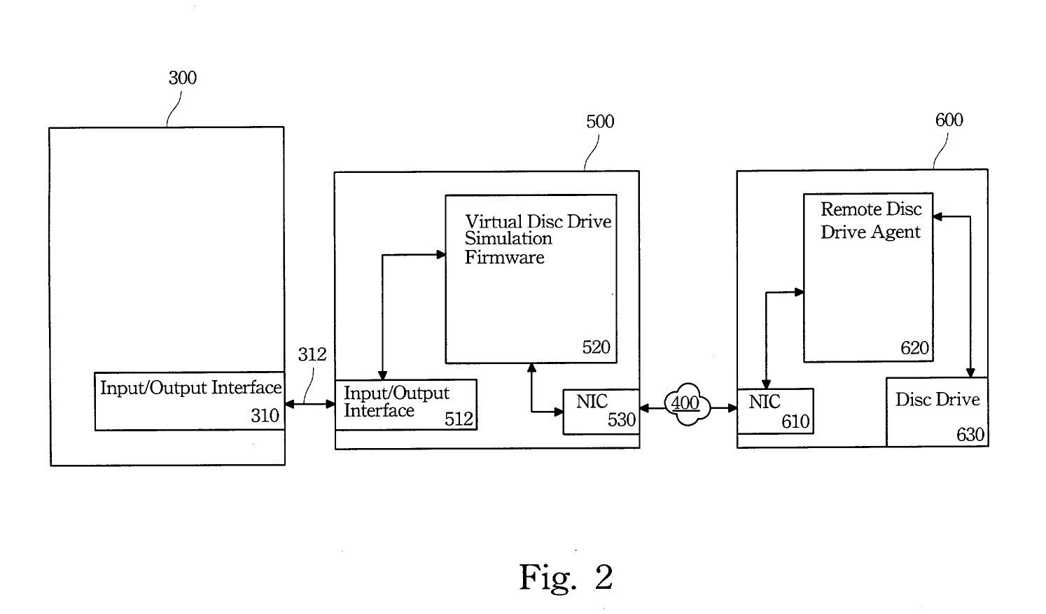

FIG. 2 is a block schematic diagram of a virtual disc drive control device according to the present invention. The following detailed description illustrates functions and theories of the virtual disc drive control device of the present invention with reference to FIG. 2. An input/output interface 512 of the virtual disc drive control device 500 connects to an input/output interface 310 of the blade server 300 by a cable 312. Incidentally, a network interface controller (NIC) 530 of the virtual disc drive control device 500 further connects to a NIC 610 of a remote computer 600 via the network 400 for controlling the blade server 300. The input/output interface 310 and 512 are USB ports, IEEE 1394 ports, or any other input/output ports with series connection function. The cable 312 is a corresponding cable of the input /output interface 310 and 512.

If a blade server 300 turns on and requests access to an optical disc drive and even to read a system boot image file, the virtual disc drive control device 500 according to the present invention gets a command form the blade server 300 and a virtual disc drive simulation firmware 520 determines whether or not the command can be answered directly by the virtual disc drive control device 500. If the command can be directly answered by the virtual disc drive control device 500, for example an insert optical disc command or a reject optical disc command, the virtual disc drive control device 500 replies the command by simulating a local external optical disc drive reply of the blade server 300. If the command cannot be directly answered by the virtual disc drive control device 500, for example a read data command or a write data command, the virtual disc drive control device 500 transforms the command into network packets and transmit the same to the NIC 610 of the remote computer 600 through the NIC 530 and the network 400. When the remote computer 600 receives these network packets, a remote disc drive agent 620, which is a CPU of the remote computer 600 executing a remote disc drive agent program, analyzes the command from the virtual disc drive control device 500 and then reads/writes data from/into the disc drive 630, and even reads specific data, such as a system boot image file, an operating system file, or a system diagnosis program. The remote computer 600 transforms the read data and results of the command into network packets and transmits the same to the virtual disc drive control device 500 from the NIC 610 through the network 400.

The virtual disc drive control device 500 receives these network packets from the remote computer 600 and transforms the same into digital signals to fulfill a specification of the input/output interface 310 and 512, and then transmits the same to the blade server 300. When the blade server 300 receives these digital signals, a reply is simulated as the local external optical disc drive reply, and the blade server 300 then proceeds with work according to the simulation reply.

The foregoing disc drive can be a compact disc read only memory (CD-ROM), a digital video disc ROM (DVD-ROM), a compact disc-rewritable (CD-RW), a digital video disc random access memory (DVD-RAM), or even a floppy disc drive. By way of the virtual disc drive control device according to the present invention, the remote disc drive can be simulated as a local optical disc drive or a local floppy disc drive.

The virtual disc drive control device according to the present invention is not limited to work with the blade server. The present invention is suitable for allowing a normal server computer to access the remote optical disc drive, and furthermore the present invention is suitable for allowing a personal computer to access the remote optical disc drive. Moreover, the present invention is not limited to simulation of a remote optical disc drive as a local optical disc drive, and the present invention is also proper for simulation of any remote peripheral device as any local peripheral device with a corresponding firmware. Therefore, the present invention effectively supports a computer apparatus with the present invention in the access of a remote peripheral device, including reading a system boot image file to reboot the computer apparatus, even when the computer apparatus does not support a network support operating system. Accordingly, the present invention improves the network management convenience.

The remote disc drive agent program of the remote computer can be either a predetermined application program installed in the remote computer or a browser program supporting Java applets. If the remote computer uses the predetermined application program, the remote computer has to install the predetermined application program before the virtual disc drive control device according to the present invention can access the remote computer. If the remote computer uses a browser with Java applet support, the remote computer can directly download the management applet from the control device and immediately be controlled by the local computer.

By using either the predetermined application program installed in the remote computer or the management applet downloaded from the control device, the virtual disc drive control device according to the present invention automatically simulates a predetermined local peripheral device when the local computer connects to the virtual disc drive control device. When the virtual disc drive control device receives a connecting response from the remote computer, the local computer can control the peripheral device of the remote computer as a local peripheral device by way of the virtual disc drive control device. The present invention is not limited to a connection sequence; either the remote computer first connects to the present invention or the local computer first connects to the present invention. After both computers connect to the present invention, the present invention can simulate a local peripheral device for the local computer.

Therefore, with the control device according to the present invention, the local computer need not use any operating system and can access the remote peripheral device. The present invention improves the function and convenience of network management so that the local computer can access the remote peripheral device by way of the network, and furthermore the local computer can use the system boot image file on the remote device to reboot the local computer. The present invention therefore provides a novel function for the network management.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A virtual disc drive control device, the control device connected to a local computer and a remote computer via a network, the control device comprising:
a control device input/output interface connecting to a local computer input/output interface of the local computer by a cable to receive a local computer information from the local computer input/output interface;
a virtual disc drive simulation firmware connecting to the control device input/output interface, the virtual disc drive simulation firmware simulating the control device into a local virtual disc drive, the virtual disc drive simulation firmware further receiving the local computer information from the control device input/output interface, wherein:
when the virtual disc drive simulation firmware replys directly to the local computer information, the virtual disc drive simulation firmware replies to the local computer information with local computer response information; and
when the virtual disc drive simulation firmware does not reply directly to the local computer information, the virtual disc drive simulation firmware transforms the local computer information into local computer network packets according to a predetermined network communication protocol; and
a control device network interface controller connecting the virtual disc drive simulation firmware for sending the local computer network packets to the remote computer and receiving remote computer response network packets from the remote computer when the local computer information is not able to reply directly to the control device, wherein the virtual disc drive simulation firmware transforms the remote computer response network packets into a local computer response information and the control device input/output interface transmits the local computer response information to the local computer.

2. The control device of claim 1, wherein the remote computer comprises:
a remote computer network interface controller connected to the network to receive the local computer network packets;
a central processing unit connecting to the remote computer network interface controller and executing a remote disc drive agent program to transform the local computer network packets into remote computer information; and
a remote optical drive disc connecting to the central processing unit to receive the remote computer information and reply to the remote computer information with a remote computer response information to the central processing unit, wherein the central processing unit transforms the remote computer response information into the remote computer response network packets and the remote computer network interface controller transmits the remote computer response network packets to the control device network interface controller via the network.

3. The control device of claim 2, wherein the remote disc drive agent program comprises a predetermined application program installed on the remote computer.

4. The control device of claim 2, wherein the remote disc drive agent program comprises a Java applet automatically downloaded from the control device when the remote computer connects to the control device.

5. The control device of claim 1, wherein the control device input/output interface comprises a bus input/output interface with a series connection capability.

6. The control device of claim 5, wherein the bus input/output interface comprises a universal serial bus (USB) input/output interface.

7. The control device of claim 5, wherein the bus input/output interface comprises an IEEE 1394 bus input/output interface.

8. The control device of claim 1, wherein the predetermined network communication protocol comprises a TCP/IP network communication protocol.

9. A virtual disc drive control system, comprising:
a local computer comprising a local computer input/output interface;
a remote computer comprising a remote computer network interface controller, a central processing unit connected to the remote computer network interface controller, and a remote optical drive disc connected to the central processing unit;
a network connecting between the local computer and the remote computer to transmit network packets for local computer and the remote computer; and
a virtual disc drive control device connected between the local computer and the network, the virtual disc drive control device comprising:
a control device input/output interface connected to the local computer input/output interface by a cable to receive local computer information from the local computer input/output interface;
a virtual disc drive simulation firmware connected to the control device input/output interface, the virtual disc drive simulation firmware simulating the virtual disc drive control device into a local virtual disc drive, the virtual disc drive simulation firmware further receiving a local computer information from the control device input/output interface; wherein
when the virtual disc drive simulation firmware replys directly to the local computer information, the virtual disc drive simulation firmware replies to the local computer information with a local computer response information; and
when the virtual disc drive simulation firmware does not reply directly to the local computer information, the virtual disc drive simulation firmware transforms the local computer information into local computer network packets according to a predetermined network communication protocol; and
a control device network interface controller connecting the virtual disc drive simulation firmware to the network for sending the local computer network packets to the remote computer when the local computer information is not able to reply directly to the control device,
wherein the remote computer network interface controller receives the local computer network packets via the network, the central processing unit executing a remote disc drive agent program transforms the local computer network packets into a remote computer information, the remote optical drive disc replies to the remote computer information with a remote computer response information to the central processing unit, the central processing unit transforms the remote computer response information into the remote computer response network packets, the remote computer network interface controller transmits the remote computer response network packets to the control device network interface controller via the network, and the virtual disc drive simulation firmware transforms the remote computer response network packets into the local computer response information and the control device input/output interface transmits the local computer response information to the local computer.

10. The virtual disc drive control system of claim 9, wherein the remote disc drive agent program comprises a predetermined application program installed on the remote computer.

11. The virtual disc drive control system of claim 9, wherein the remote disc drive agent program comprises a Java applet automatically downloaded from the control device when the remote computer connects to the control device.

12. The virtual disc drive control system of claim 9, wherein the control device input/output interface comprises a bus input/output interface with a series connection capability.

13. The virtual disc drive control system of claim 12, wherein the bus input/output interface comprises a universal serial bus (USB) input/output interface.

14. The virtual disc drive control system of claim 12, wherein the bus input/output interface comprises an IEEE 1394 bus input/output interface.

15. The virtual disc drive control system of claim 9, wherein the predetermined network communication protocol comprises a TCP/IP network communication protocol.

16. A virtual computer peripheral equipment control device, the control device connected to a local computer and a remote computer via a network, the control device comprising:
a control device input/output interface connected to a local computer input/output interface of the local computer by a cable to receive a local computer information from the local computer input/output interface;
a virtual computer peripheral equipment simulation firmware connected to the control device input/output interface, the virtual computer peripheral equipment simulation firmware simulating the control device into a local computer peripheral equipment, the virtual computer peripheral equipment simulation firmware further receiving the local computer information from the control device input/output interface, wherein:
when the virtual computer peripheral equipment simulation firmware replys directly to the local computer information directly, the virtual computer peripheral equipment simulation firmware replies to the local computer information with a local computer response information; and
when the virtual computer peripheral equipment simulation firmware does not reply directly to the local computer information, the virtual computer peripheral equipment simulation firmware transforms the local computer information into local computer network packets according to a predetermined network communication protocol; and
a control device network interface controller connecting the virtual computer peripheral equipment simulation firmware to the network for sending the local computer network packets to the remote computer and receiving remote computer response network packets from the remote computer when the local computer information is unable to reply directly to the control device, wherein the virtual computer peripheral equipment simulation firmware transforms the remote computer response network packets into the local computer response information and the control device input/output interface transmits the local computer response information to the local computer.

17. The control device of claim 16, wherein the remote computer comprises:
a remote computer network interface controller connected to the network to receive the local computer network packets;
a central processing unit connected to the remote computer network interface controller and executing a remote disc drive agent program to transform the local computer network packets into a remote computer information; and
a remote computer peripheral equipment connected to the central processing unit to receive the remote computer information and reply to the remote computer information with a remote computer response information to the central processing unit, wherein the central processing unit transforms the remote computer response information into the remote computer response network packets and the remote computer network interface controller transmits the remote computer response network packets to the control device network interface controller via the network.

18. The control device of claim 16, wherein the control device input/output interface comprises a universal serial bus (USB) input/output interface.

19. The control device of claim 16, wherein the control device input/output interface comprises an IEEE 1394 bus input/output interface.

20. The control device of claim 16, wherein the predetermined network communication protocol comprises a TCP/IP network communication protocol.
